(19) United States
(12) Patent Application Publication
(10) Pub. No.: US 2025/0116766 A1
(43) Pub. Date: Apr. 10, 2025

(54) Ultrasonic Sensor Package with Decoupled Acoustic Modes

(71) Applicant: InvenSense, Inc., San Jose, CA (US)

(72) Inventors: Benjamin Eric Eovino, Oakland, CA (US); Stefon Eric Shelton, Oakland, CA (US); Fabian Thomas Goericke, Berkeley, CA (US)

(21) Appl. No.: 18/902,498

(22) Filed: Sep. 30, 2024

Related U.S. Application Data
(60) Provisional application No. 63/587,740, filed on Oct. 4, 2023.

(51) Int. Cl. G01S 7/521

(52) U.S. Cl. CPC G01S 7/521

(57) ABSTRACT

A piezoelectric micromachined ultrasound transducer (PMUT) sensor is implemented with a microelectromechanical sensor (MEMS) die including a membrane of the PMUT sensor that transmits and receives acoustic signals. A back volume within the MEMS sensor package has an acoustic resonance mode that is within an operating frequency range of the MEMS sensor. The MEMS die is located within the MEMS sensor package such that an acoustic pressure that is applied to the membrane is balanced over the membrane, such that the back volume acoustic resonance mode is decoupled from the membrane operating mode.

### CROSS-REFERENCE TO RELATED APPLICATION

This application claims priority to U.S. Provisional Patent Application No. 63/587,740, filed Oct. 4, 2023, and entitled “PMUT Package with Decoupled Acoustic Modes,” which is incorporated by reference herein in its entirety for all purposes.

### BACKGROUND

Ultrasonic sensors such as a piezoelectric micromachined ultrasonic transducer (“PMUT”) sensor transmit an ultrasound signal or wave into an environment of interest and measure reflected signals that are received over time, with the timing and magnitude of the reflected or echo signal corresponding to the distance to an object of interest and the characteristics of the object causing the reflection. Accordingly, PMUT sensor are used for a variety of applications such as fingerprint sensors and object detection systems, which in turn are integrated into numerous end use devices such as security systems, door locks, computers, smart phones, tablet devices, vehicles, and the like.

A PMUT sensor is implemented as microelectromechanical system (MEMS) device including a membrane that generates an acoustic output signal based on an electrical transmission signal applied across a piezoelectric material layer, for example, by electrodes located on each side of the piezoelectric material layer. Similarly, an acoustic signal received at the piezoelectric material layer of the membrane is converted by the piezoelectric material layer to an electrical reflection signal which is received and processed via the adjacent electrode layers and additional processing circuitry. The PMUT sensor is typically located in a PMUT sensor package with one side of the membrane open to an external environment such as via a port and an internal back cavity volume encapsulated within a packaging of the PMUT sensor package on the opposite side of the membrane. The back cavity volume may also be acoustically excited by the movement of the membrane, with a particularly large signal occurring when the membrane is excited at a frequency corresponding to an acoustic resonance mode of the back volume. In such instances, much of the transmit and receive power of the PMUT sensor may be consumed in exciting the back cavity rather than in the transmission and reception (e.g., pulse/echo or pitch/catch) of the signal of interest.

### SUMMARY

In an embodiment of the present disclosure, an ultrasonic sensor comprises a sensor package comprising a back cavity having an acoustic resonance mode at a first frequency and a port exposed to an external environment. The ultrasonic sensor also includes a MEMS die exposed to the back cavity and the port, the MEMS die comprising a membrane of the ultrasonic sensor having an operating frequency range that includes the first frequency, wherein based on a location of the MEMS die within the back cavity an applied acoustic pressure on the membrane corresponding to the acoustic resonance mode is balanced over the membrane.

In an embodiment of the present disclosure a PMUT sensor comprises a sensor package comprising a back cavity having an acoustic resonance mode at a first frequency and a port exposed to an external environment. The PMUT sensor also includes a PMUT membrane located within the sensor package and having an operating frequency range that includes the first frequency, wherein based on a location of the PMUT membrane within the sensor package an applied acoustic pressure on the membrane corresponding to the acoustic resonance mode is balanced over the membrane.

In an embodiment of the present disclosure, a PMUT sensor comprises a lid and a base substrate, wherein the lid and substrate define a back volume. The PMUT sensor also includes processing circuitry located within the back volume and a PMUT membrane located within the back volume, wherein based on a location of the PMUT membrane within the back volume an applied acoustic pressure on the membrane corresponding to an acoustic resonance mode of the back volume is balanced over the membrane.

### BRIEF DESCRIPTION OF DRAWINGS

The above and other features of the present disclosure, its nature, and various advantages will be more apparent upon consideration of the following detailed description, taken in conjunction with the accompanying drawings in which:

FIG. 1 shows an illustrative PMUT system in accordance with an embodiment of the present disclosure;

FIG. 2 depicts an exemplary PMUT sensor with an unbalanced acoustic pressure profile applied to a membrane of a PMUT due to a back cavity acoustic resonance mode in accordance with an embodiment of the present disclosure;

FIG. 3 depicts an exemplary PMUT sensor with a balanced acoustic pressure profile applied to a membrane of a PMUT due to a back cavity acoustic resonance mode in accordance with an embodiment of the present disclosure;

FIG. 4 depicts an exemplary PMUT sensor with a plurality of acoustic pressure profiles corresponding to different acoustic resonance modes of a back cavity of the PMUT sensor in accordance with an embodiment of the present disclosure;

FIG. 5 depicts plots of a net applied acoustic pressure to a PMUT membrane based on variations of design parameters of the PMUT sensor in accordance with an embodiment of the present disclosure;

FIG. 6 depicts an exemplary top-port PMUT sensor in accordance with an embodiment of the present disclosure;

FIG. 7 depicts a plurality of acoustic pressure profiles for a circular version of the PMUT sensor of FIG. 6 corresponding to different acoustic resonance modes of a back cavity of the PMUT sensor in accordance with an embodiment of the present disclosure;

FIG. 8 depicts a plurality of acoustic pressure profiles for a rectangular version of the PMUT sensor of FIG. 6 corresponding to different acoustic resonance modes of a back cavity of the PMUT sensor in accordance with an embodiment of the present disclosure; and

FIG. 9 depicts exemplary steps of designing a PMUT sensor with a balanced membrane for acoustic resonance modes of the PMUT sensor back cavity in accordance with an embodiment of the present disclosure.

### DETAILED DESCRIPTION

An ultrasonic sensor such as PMUT sensor includes a PMUT that is fabricated such as through MEMS fabrication techniques for a particular purpose such as to transmit acoustic signals (e.g., based on an electrical transmission signal provided by processing circuitry to excite a membrane of the PMUT) towards an external volume of interest, receive reflections of those transmitted signals, and generate electrical reflection signals based on the received reflections. Although the present disclosure may be described in the context of the ultrasonic sensor being a PMUT sensor having a MEMS-fabricated PMUT with a membrane. The PMUT is implemented such as by a MEMS die that is a component of a PMUT sensor package, which in turn partially encloses the PMUT and provides a signal path (e.g., via a port) for transmitting and receiving signals to and from an external volume. In some examples, the PMUT membrane transmits and receives acoustic signals via a front cavity of the MEMS die and a port of the PMUT sensor package that is exposed to the external volume. The PMUT sensor package (e.g., including layers providing packaging for the PMUT sensor such as a lid and base substrate) define an enclosed back cavity for the PMUT sensor, in some instances with other components such as an ASIC coupled to one of the PMUT sensor package layers within the back cavity. The air enclosed in the back cavity can be excited by the vibration of the membrane in transmitting and receiving acoustic signals, with the amplitude associated with the excitation being most acute at frequencies of acoustic resonance modes of the back cavity. This issue may be particularly acute in MEMS ultrasonic sensors, in which the dimensions of the sensor package are comparable to the ultrasound acoustic wavelength. Thus, when an acoustic resonance mode of the back cavity is within an operating frequency range of the PMUT, energy that would otherwise be utilized to transmit an acoustic signal or that would otherwise convert a reflected acoustic signal into an electrical reflection signal is instead utilized to excite the back cavity.

The pressure profile generated by excitation of the back cavity at a frequency associated with an acoustic resonance mode may change based on the characteristics of PMUT sensor design, such as the dimensions of the back cavity and the relative location of the PMUT membrane of the MEMS die relative to the back volume. The relative dimensions of the volume of the back cavity, and thus the pressure profiles of the acoustic resonance modes, can be optimized such as by changing the shape and overall volume of the back cavity (e.g., based on dimensions of a lid or other enclosing layers) and the relative locations of components within the back cavity, as well as by modifying component locations and sizes (e.g., of an ASIC in the back cavity). The location of the MEMS die within the back cavity is located such that a net pressure experienced by the PMUT membrane of the MEMS die due to excitation at relevant acoustic resonance modes of the back cavity (e.g., acoustic resonance modes within the PMUT's operating frequency range) is balanced (e.g., within 1%, 3%, 5% of a zero net pressure, or another preselected threshold). In this manner, the acoustic resonance modes of the back cavity are decoupled from the operational modes of the PMUT sensor.

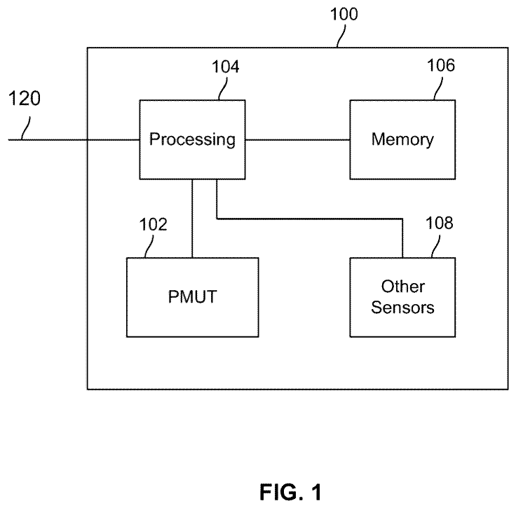

FIG. 1 shows an illustrative PMUT system 100 in accordance with an embodiment of the present disclosure. Although particular components are depicted in FIG. 1, it will be understood that other suitable combinations of PMUTs, other sensors (e.g., MEMS or pressure sensors) processing components, memory, and other circuitry may be utilized as necessary for different applications and systems. In accordance with the present disclosure, the PMUT system may include a PMUT sensor 102 as well as additional sensors 108. Although the present disclosure will be described in the context of signals received from certain PMUT sensor designs and configurations, it will be understood that the decoupling of the acoustic resonance modes of a back cavity within the operational frequency range of the PMUT sensor from the transmission and reception of acoustic signals in accordance with the present disclosure may be utilized with a variety of PMUT designs, including a variety of different membrane and packaging materials, membrane and packaging layers, membrane and packaging shapes, fabrication techniques, and combinations thereof.

Processing circuitry 104 may include one or more components providing processing based on the requirements of the PMUT system 100. In some embodiments, processing circuitry 104 may include hardware control logic that may be integrated within a chip of a sensor (e.g., of a die of a PMUT sensor 102 or other sensors 108, or on an adjacent portion of a chip to the PMUT sensor 102 or other sensors 108) to control the operation of the PMUT sensor 102 or other sensors 108 and perform aspects of processing for the PMUT sensor 102 or the other sensors 108. In some embodiments, the PMUT sensor 102 and other sensors 108 may include one or more registers that allow aspects of the operation of hardware control logic to be modified (e.g., by modifying a value of a register). In some embodiments, processing circuitry 104 may also include a processor such as a microprocessor that executes software instructions, e.g., that are stored in memory 106. The microprocessor may control the operation of the PMUT sensor 102 by interacting with the hardware control logic and processing signals received from PMUT sensor 102. The microprocessor may interact with other sensors 108 in a similar manner. In some embodiments, some or all of the functions of the processing circuitry 104, and in some embodiments, of memory 106, may be implemented on an application specific integrated circuit (“ASIC”) and/or a field programmable gate array (“FPGA”), for example, within a back cavity of the PMUT sensor.

Although in some embodiments (not depicted in FIG. 1), the PMUT sensor 102 or other sensors 108 may communicate directly with external circuitry (e.g., via a serial bus or direct connection to sensor outputs and control inputs), in an embodiment the processing circuitry 104 may process data received from the PMUT sensor 102 and other sensors 108 and communicate with external components via a communication interface 110 (e.g., a serial peripheral interface (SPI) or 12C bus, in automotive applications a controller area network (CAN) or Local Interconnect Network (LIN) bus, or in other applications a suitably wired or wireless communications interface as is known in the art). The processing circuitry 104 may convert signals received from the PMUT sensor 102 and other sensors 108 into appropriate measurement units (e.g., based on settings provided by other computing units communicating over the communication interface 110).

The PMUT sensor 102 may be implemented in a PMUT sensor package having back cavity acoustic resonance modes that are decoupled from the acoustic transmission and reception of the PMUT sensor 102. Although such back cavity acoustic resonance modes may occur within the operating frequency range of the PMUT sensor, the membrane positioned on a MEMS die located within and defining in part the back volume of the PMUT sensor package may be positioned within the back cavity such that any applied acoustic pressure within the back cavity at the acoustic resonance mode is balanced over the membrane. In this manner, a negligible portion of the overall signal power used for transmission and reception of acoustic signals via the membrane is consumed by exciting the acoustic resonance mode. Other acoustic resonance modes may have resonance frequencies that are outside of the operating frequency range of the PMUT sensor 102.

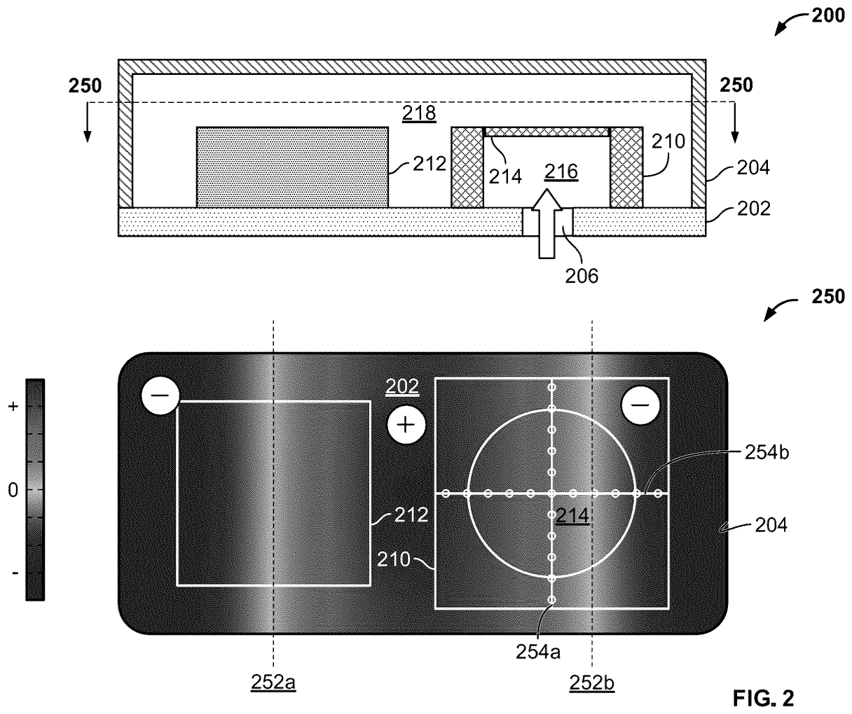

FIG. 2 depicts an exemplary PMUT sensor with an unbalanced acoustic pressure profile applied to a membrane of a PMUT due to a back cavity acoustic resonance mode in accordance with an embodiment of the present disclosure. The PMUT sensor of FIG. 2 includes a PMUT sensor package 200, which depicts a horizontal section view of the sensor package, while top section view 250 shows an acoustic pressure profile of certain components within the PMUT sensor package 200 based on a top view from section line 250. It is understood that a PMUT sensor package 200 may have a number of different configurations and components. In an exemplary embodiment, PMUT sensor 200 is constructed such as from MEMS, semiconductor, and laminate components, and includes a base substrate 202, lid 204, port 206, a PMUT implemented as a MEMS die 210 including a membrane 214, and processing circuitry such as ASIC 212. The packaging of the PMUT sensor package 200 includes a base substrate layer 202 and a lid 204, with a port 206 that is within and through base substrate 202. MEMS die 210 is fixed to base substrate 202 and includes a membrane 214 of a PMUT, wherein a volume is in fluidic communication with port 206 and enclosed by MEMS die 210 to define a front cavity 216. Processing circuitry such as an ASIC die 212 is located within an enclosed back cavity volume of the PMUT sensor package 200, for example, bonded to an upper surface of base substrate 202. In the embodiment of FIG. 2, the enclosed interior volume of the PMUT sensor package is a back cavity 218 that is defined by the geometrical configurations of the internal faces of the base substrate 202, the lid 204, and the internal components (such as the MEMS die 210 and ASIC die 212). The back cavity encloses a volume that may include a gas such as air at atmospheric pressure, or in other embodiments, other gasses and pressures including vacuum. In the exemplary embodiment, the components are shown at specific positions with particular dimensions, but they may be modified to accommodate different PMUT configurations and designs. Further, additional components may be added and/or removed, and the relative positions of the components may be altered (e.g., moving the ASIC die to the exterior of sensor package or adding a filler material within the back cavity).

Base substrate 202 provides a supporting material layer (e.g., of a package laminate or other suitable material) for other components of PMUT sensor package 200, and in some examples, an interface for electrical and/or mechanical connections to other components of an end use device (e.g., providing bond pads to communicate electrical signals to and from ASIC 212, and physical bonding or other connections to other components such as to provide access of port 206 to a region of interest for transmission and reflection of acoustic signals). In the embodiment of FIG. 2, base substrate 202 can provide for a physical attachment surface for the bonding of other functional components such as a MEMS die 210, ASIC die 212, lid 204, or other processing circuitry or sensors. The base substrate 202 may also provide circuit paths for the routing of electrical signals via electrical signal paths (not depicted) within base substrate layer 202. Along with the lid 204, base substrate 202 provides structural support to the entire package. In the embodiment of FIG. 2, each of base substrate 202 and lid 204 that form the external packaging are generally rectangular, but it will be understood that the base substrate 202, lid 204, and other components can be configured in a variety of shapes such as rectangular shapes, circular shapes, oval shapes, polygon shapes, irregular shapes, and combinations thereof.

A port 206 can be fabricated through the base substrate 202 to allow for a fluidic path (e.g., via front cavity 216) between the internal membrane 214 of the MEMS die 210 and an external volume of interest. The port 206 is a hole within the base substrate 202 that generally allows direct access to the PMUT membrane 214. The exposed volume between the membrane 214 and the port 206 and enclosed by the MEMS die is known as the front cavity 216. By varying the geometry (e.g., circular, rectangular, ovular) and overall size of the port 206, the acoustics of the front cavity 216 can be modified. Thus, port 206 can have a variety of shapes and configurations to provide appropriate access to the front cavity exposed to the membrane 214 of the PMUT, such as a rectangular shape, circular shape, oval shape, polygon shape, or irregular shape. Moreover, a port 206 may include features for mitigating undesired interference with the transmission and reception of signals via the port 206 and front volume 216, such as to block light or particles from entering the port 206 and front cavity 216.

While the port 206 is depicted as extending through a base substrate 202 in FIG. 2, it will be understood that a port 206 may be located on any suitable surface to provide a path for transmission and reception of an acoustic signal, such as a semiconductor sidewall (not depicted) or lid 204, with appropriate modifications to the location of the MEMS die 210 and front and back cavities. In additional embodiments (not depicted), the port 206 may extend through the lid such that what is referred to as the back cavity 218 in the present embodiment can function as a front cavity by facilitating transmission of signals, while what is referred to as the front cavity 216 in the present embodiment is an enclosed volume (e.g., with no port to be in fluidic connection with external volumes) to be optimized for decoupling of the back volume acoustic resonance mode as described herein.

The lid 204 can be created using a variety of techniques and materials (e.g., semiconductor, metal, polymer, composite) and can provide structural support and a physical attachment surface for the bonding of other functional components. Further, the lid 204 provides a physical barrier, and thus protection, for the entire PMUT sensor package 200, including the MEMS die 210 and ASIC die 212. The acoustic resonance modes of the back cavity 218 are in part dictated by the various geometrical dimensions of the lid, as well as its spatial location compared to components within the back cavity. Changes in the volume enclosed by the lid 204 can in turn alter acoustic resonance modes (e.g., frequency, pressure distribution, amplitude, etc.) as can changes in relative dimensions (e.g., height vs. width vs. depth) and relative sizes and positions of components contained within the lid.

MEMS die 210 is in contact with both the front cavity 216 and the back cavity 218 and is depicted in simplified form herein. A PMUT can be fabricated using MEMS semiconductor fabrication processing as the MEMS die 210, with the MEMS die 210 also includes structural features such as for bonding and attaching to base substrate 202. It will be understood that while the present embodiments are described in the context of a MEMS die 210 including a membrane 214 of a PMUT, in other embodiments PMUTs fabricated from different processes and materials may have undesired acoustic resonance modes decoupled from PMUT operation using the structures and processes described herein. In the embodiment of FIG. 2, the MEMS die 210 has a rectangular shape and includes a circular membrane 214 in contact with both the front cavity 216 and back cavity 218, however each of the MEMS die 210 and membrane 214 may have different shapes, such as rectangular shapes, circular shapes, oval shapes, polygon shapes, irregular shapes, and combinations thereof. The membrane 214 receives electrical transmission signals (e.g., from processing circuitry such as ASIC 212) that are converted by the membrane 214 into acoustic transmission signals and transmitted via port 206 into the external environment, and which are then reflected back to the membrane 214 via port 206 by objects within an external environment as acoustic reflection signals and converted by the membrane 214 into electrical reflection signals for further processing by processing circuitry such as ASIC 212.

Modifications to the geometry, size, and spatial location of the MEMS die 210 not only impact the acoustic properties of the front cavity 216, but also the acoustic resonance modes of the back cavity 218. The PMUT membrane 214 is a component of the MEMS die 210 that is exposed to both the front cavity 216 and the back cavity 218 and whose thickness can vary (generally the low micrometer range). Further, the dimensions and shape of the MEMS die 210 (e.g., thickness and lateral dimensions, in defining the front cavity and back cavity) can have substantial impact on the back cavity 218 acoustic resonance modes. The PMUT has an operating frequency range that is based on the PMUT and membrane 214 design. As described herein, a number of acoustic resonance modes of the back cavity 218 may be within the operating frequency range of the PMUT such that power that would otherwise be utilized in the transmitting and receiving of acoustic signals is used to “power” the acoustic resonance modes. Absent the decoupling of acoustic resonance modes from the PMUT membrane 214 as described herein, the interaction with the acoustic resonance modes within the back cavity diminishes the sensitivity and accuracy of the PMUT.

Processing circuitry (e.g., ASIC die 212) for interfacing with the membrane 214 and other circuitry of the MEMS 210 die and other external circuitry is present within the back volume 218 of the PMUT sensor package 200. While depicted as an ASIC die 212 within FIG. 2, the processing circuitry can include other circuitry and/or additional processing circuitry may also be housed with an ASIC 212 in the back volume 218. The ASIC die 212 can generate electrical signals that are to be converted into acoustic transmission signals via the PMUT membrane 214, and also process the electrical signals produced by acoustic waves reflecting back to the PMUT membrane 214. Modifications to the geometry, size, and spatial location of other processing circuitry such as an ASIC die 212 can impact the acoustic resonance modes of the back cavity 218. Encapsulation materials, epoxies, and films (not depicted) that can cover the ASIC die 212 can also alter the acoustic resonance modes of the back cavity 218 such as the shape and overall enclosed volume, and any reflection, attenuation, or amplification of the acoustic waves that are produced externally or internally. Thus, in addition to the decoupling described herein, a PMUT sensor design may also include modifications to the size, shape, location, and other properties of the processing circuitry (e.g., ASIC die 212) to modify characteristics (e.g., frequency, amplitude, locations, etc.) of particular acoustic resonance modes.

The back cavity 218 is an enclosed volume defined by a number of characteristics such as the geometrical configuration, thickness, and spatial location of the base substrate 202, lid 204, MEMS die 210, and ASIC die 212. The presence of other sensors, components, and encapsulation materials will also impact the back cavity volume. All these characteristics and configurations will alter the number and specific characteristics of the acoustic resonance modes present within the back cavity 218. The acoustic vibrations produced by the PMUT membrane 214 may couple with such acoustic resonance modes leading to signal interference and attenuation, which would reduce the overall efficiency of the PMUT sensor package 200 (i.e., energy sent by the membrane 214 to produce acoustic waves within the front cavity 216 and exit through the port 206 would be used to excite the volume within the back cavity 218, thus reducing the amplitude and fidelity of acoustic waves exiting through the port 206).

Pressure profile 250 shows an exemplary acoustic pressure profile associated with one particular resonance mode of the PMUT sensor package 200 based on a top view from section line 250. The negative and positive pressure regions are represented as dark gray, while locations of a zero net pressure are represented as light gray. Positive (“+”) and negative (“−”) phase pressure regions are depicted by labels within continuous gray regions. Under the acoustic mode present within pressure profile 250, the first pressure node line 252a is produced vertically across the ASIC die 212 and the second pressure node line 252b is produced vertically across the MEMS die 210 and membrane 214. The second pressure node line 252b does not align with either the vertical 254a or horizonal 254b spatial lateral symmetry lines present across the PMUT membrane 214, thus producing an imbalanced pressure profile across the entirety of the membrane 214, resulting in a coupling between the PMUT and the acoustic resonance mode. In this embodiment, at a set frequency, a specific acoustic pressure profile with only two pressure node lines exists, but in other PMUT configurations and designs (e.g., containing other components, sensors, processing circuitry, dimensions, etc.) there may be more or less nodes and different acoustic pressure profiles as both the frequency and operating bands of the PMUT sensor package 200 may change. For example, in some embodiments multiple acoustic resonance modes may occur at close frequencies, such that both may be coupled to PMUT operation at an operating frequency.

An acoustic excitation of the air in the back cavity 218 produces an acoustic pressure profile across the PMUT sensor package 200. The geometrical configuration, location, size, shape of the components within the PMUT sensor package 200 (e.g., ASIC die 212), in addition to the presence of other objects (e.g., encapsulation materials, epoxies, etc.), impact the acoustic pressure profiles and node line locations. In an exemplary embodiment of FIG. 250, the first pressure node line 252a is across the ASIC die 212 and the second pressure node line 252b is across the MEMS die 210 and membrane 214. Depending on both the applied frequency and the operating frequency band of the PMUT sensor package 200, the acoustic pressure profiles across all the components may appear differently (e.g., pressure node number, location, and shape). The alignment of the pressure node lines with the vertical 254a and horizontal 254b spatial lateral symmetry lines of the membrane 214 dictates the net pressure profile over the membrane 214. In this embodiment, at a particular resonance acoustic mode, the configuration yields a misalignment of the pressure node lines and spatial lateral symmetry lines, thus causing a non-zero net pressure (i.e., positive pressure region) across the membrane 214 leading to reduced acoustic efficiency and negatively impacting the performance of the PMUT sensor package 200 due to coupling between the PMUT and the acoustic resonance mode. Accordingly, the pressure profile is not balanced over membrane 214 for the acoustic resonance mode.

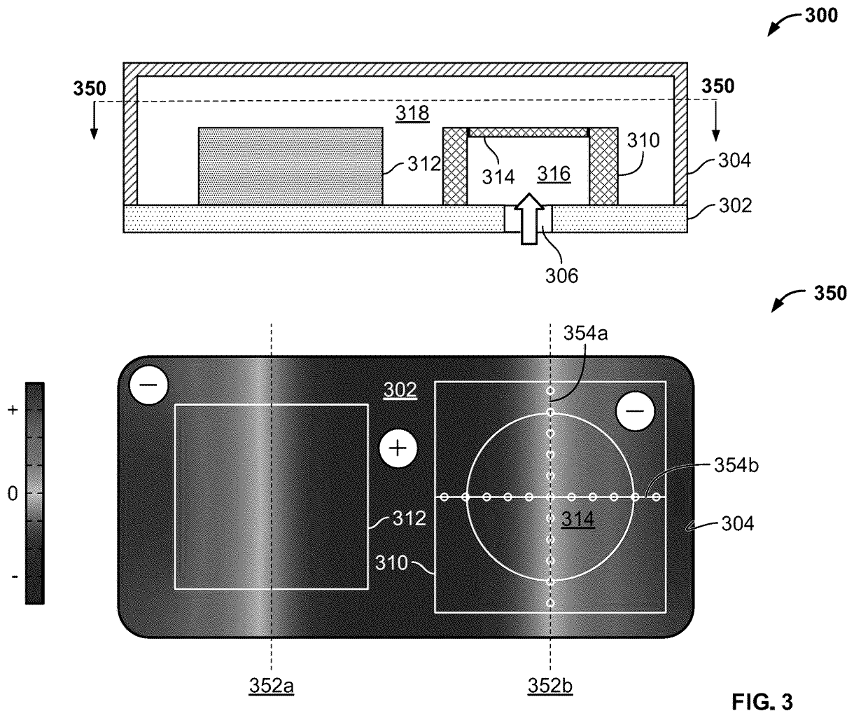

FIG. 3 depicts an exemplary PMUT sensor with a balanced acoustic pressure profile applied to a membrane of a PMUT due to a back cavity acoustic resonance mode in accordance with an embodiment of the present disclosure. The PMUT sensor of FIG. 3 includes a PMUT sensor package 300 fabricated as a MEMS package, which depicts a horizontal section view of the device, while pressure profile 350 shows an acoustic pressure profile of the PMUT sensor package 300 based on a top view from section line 350. It is understood that a PMUT sensor package 300 may have a number of different configurations and components. The PMUT sensor package 300, along with its numbered elements, is similar to and functions in a similar manner as that of PMUT sensor package 200 (and its respective components). However, the membrane 314 of the MEMS die 310, as well as the port 306, are positioned such that the acoustic pressure profile across the membrane 314 is balanced over the membrane 314, with zero or close to zero net pressure experienced by the membrane 314. In the context of the present disclosure, a membrane with a balanced acoustic pressure profile uses negligible energy exciting the back volume at its acoustic resonance mode, for example, less than 5%, 3%, or 1% of the total transmit power applied to the membrane at the acoustic resonance mode.

Pressure profile 350 shows an exemplary acoustic resonance mode pressure profile of the PMUT sensor package 300 based on a top view from section line 350. The negative and positive pressures across a location are represented as dark gray, while neutral pressures are represented as light gray. Under the acoustic resonance mode corresponding to pressure profile 350, the first pressure node line 352a (occurs vertically across the ASIC die 312 and the second pressure node line 352b occurs vertically across the MEMS die 310 and membrane 314. The second pressure node line 352b aligns with the vertical lateral symmetry line 354a across the PMUT membrane 314, thus producing a balanced pressure profile across the entirety of the membrane 314. In this embodiment, at a particular frequency associated with the acoustic resonance modes, a specific acoustic pressure profile with only 2 pressure node lines exists, but in other PMUT configurations and designs (e.g., containing other components, sensors, configurations, etc.) there may be more or less nodes and different acoustic pressure profiles as both the frequency and operating bands of the PMUT sensor package 300 may change. As described in the present disclosure, a PMUT sensor package 300 design may be configured such that for all acoustic resonance modes that correspond to the operating frequency range of the PMUT sensor package, pressure is balanced across the PMUT membrane.

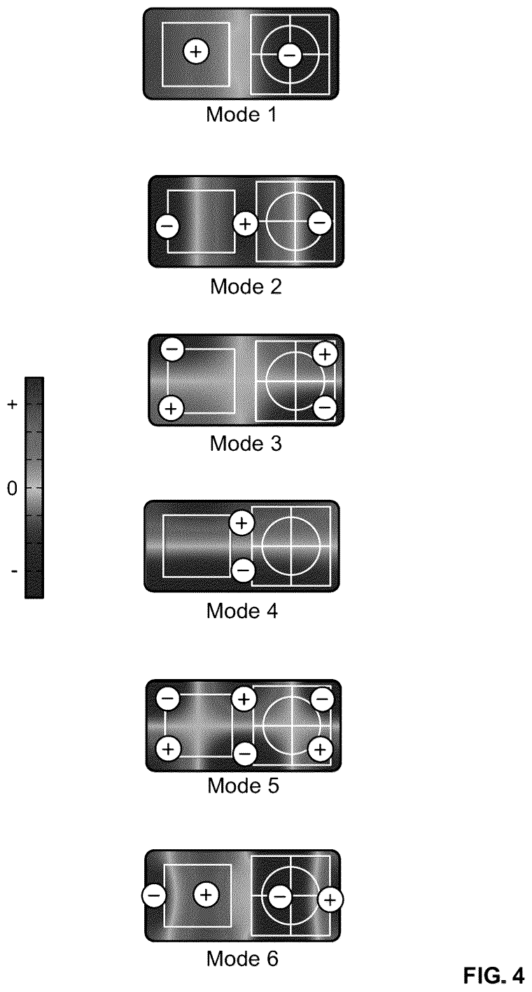

FIG. 4 depicts an exemplary PMUT sensor with a plurality of acoustic pressure profiles corresponding to different back cavity acoustic resonance modes of a back cavity of the PMUT sensor in accordance with an embodiment of the present disclosure. The negative and positive pressures across a location are represented as dark gray, while neutral pressures are represented as light gray. The respective phases of the time-harmonic pressure of the acoustic resonance modes are indicated by a “+” or “−” symbol. It will be understood that different PMUT designs and configuration will have different numbers and types of acoustic resonance modes within the operating frequency range, and that a depiction similar to FIG. 4 can be provided for such designs. In the exemplary embodiment of FIG. 4, six acoustic resonance modes are depicted for a PMUT design such as that depicted in FIG. 3.

In the embodiment of FIG. 4, an operating frequency range of the PMUT is 50-100 kHz and acoustic resonance modes 2-5 are within the operating frequency range of the PMUT, while acoustic resonance modes 1 and 6 are outside of the operating frequency range of the PMUT. For example, acoustic resonance mode 1 may occur at a frequency of 35 kHz, acoustic resonance mode 2 may occur at a frequency of 55 kHz, acoustic resonance mode 3 may occur at a frequency of 65 kHz, acoustic resonance mode 4 may occur at a frequency of 85 kHz, acoustic resonance mode 5 may occur at a frequency of 95 kHz, and acoustic resonance mode 6 may occur at a frequency of 105 kHz. It will be understood that different PMUT sensor designs and configurations will have different numbers of relevant back cavity acoustic resonance modes occurring at different frequencies, and the present disclosure may similarly be applied to other such designs and configurations by simulating back cavity acoustic resonance modes relative to the physical location of the membrane of the PMUT sensor package, utilizing test equipment to modify membrane locations and/or acoustic resonance modes, and/or testing a variety of prototypes with predetermined modifications to the membrane location and/or PMUT sensor package configurations.

In the embodiment of FIG. 4, neither of acoustic resonance mode 1 or acoustic resonance mode 6 correspond to the operating frequency range of the PMUT and thus will not be excited during proper operation of the PMUT. However, each of acoustic resonance modes 2-5 occurs within the operating frequency range and should be considered to optimize performance of the PMUT. For each of acoustic resonance modes 2-5 the acoustic resonance mode is decoupled from the operating mode of the PMUT by balancing the overall pressure applied to the PMUT membrane due to the acoustic resonance mode. For each acoustic resonance modes 2-5, the PMUT design is such that the applied pressure profiles are oriented over the PMUT membrane about one or more lateral symmetry lines of the PMUT membrane (e.g., for a circular membrane, diameter lines intersecting at right angles at a center point of the circular membrane).

For example, at the frequency associated with acoustic resonance mode 2, a balanced acoustic pressure profile is achieved across the PMUT membrane based on the neutral pressure occurring at the vertical lateral symmetry line of the membrane and equal and opposite positive and negative pressures (e.g., having opposite phases) on each side of the vertical lateral symmetry line. At the frequency associated with acoustic resonance mode 3, a balanced acoustic pressure profile is achieved across the PMUT membrane based on the neutral pressure occurring at the horizontal lateral symmetry line of the membrane and equal and opposite positive and negative pressures (e.g., having opposite phases) on each side of the horizontal lateral symmetry line. At the frequency associated with acoustic resonance mode 4, a balanced acoustic pressure profile is achieved across the PMUT membrane based on the neutral pressure occurring at the horizontal lateral symmetry lines of the membrane and equal and opposite positive and negative pressure patterns (e.g., having opposite phases) on each side of the vertical lateral symmetry line. [At the frequency associated with acoustic resonance mode 5, a balanced acoustic pressure profile is achieved across the PMUT membrane based on the neutral pressure occurring at the horizontal and vertical lateral symmetry lines of the membrane and equal and opposite positive and negative pressures in opposite quadrants (e.g., having opposite phases) defined by the horizontal and vertical lateral symmetry lines.

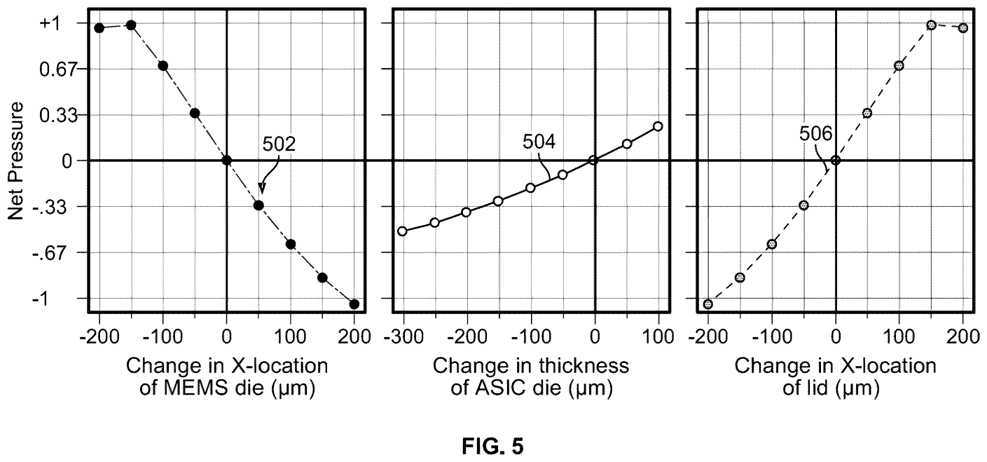

FIG. 5 depicts plots of a net applied acoustic pressure to a PMUT membrane based on variations in the PMUT sensor design parameters in accordance with an embodiment of the present disclosure. The embodiment depicted in FIG. 5 corresponds, for example, to acoustic resonance mode 2 as depicted in FIG. 4. In accordance with the present disclosure, modifications can be made to the components that collectively define the back cavity volume (e.g., base substrate, lid, ASIC/processing circuitry, MEMS die, etc.) to modify the frequencies at which acoustic resonance modes occur and the pressure profiles of the acoustic resonance modes (e.g., including locations of pressure transitions, etc.). In addition, the location of the MEMS die and corresponding PMUT membrane relative to those pressure profiles can also be modified, for example, to correspond to locations where the pressure profiles applied to the PMUT membrane are balanced based on the acoustic resonance modes. As an example, FIG. 5 depicts modification of MEMS die location, ASIC thickness, and lid location along with corresponding changes in net pressure experienced by the PMUT membrane of the MEMS die. It will be understood that the example of FIG. 5 corresponds to a particular PMUT design such as that described and depicted in FIGS. 2-4, and that similar analyses can be performed for other designs and that other parameters (e.g., y-axis MEMS die location, lid height, back cavity total volume, etc.) may be considered in designing and implementing a PMUT sensor package with decoupled acoustic resonance modes and operating modes as described herein. In the plots of FIG. 5, an x-axis “zero” value corresponds to the parameter value at which the PMUT membrane pressure balance is optimized.

Plot 502 depicts the impact of changes in the x-axis location of the MEMS die on the net pressure profiles experienced by the PMUT membrane. The abscissa of plot 502 corresponds to the x-axis location of the MEMS die within the back volume and is in units of micrometers (μm) while the ordinate of plot 502 corresponds to a normalized net pressure on the PMUT membrane ranging from +1 to −1. As is depicted by plot 502, a negative x-axis movement of the MEMS die corresponds to an increase in the net pressure on the PMUT membrane for the mode corresponding to the pressure profiles 250 and 350, as well as acoustic mode 2 of FIG. 4, in which the depicted acoustic resonance mode has a positive net pressure in the negative x-direction from the neutral pressure line/location over the MEMS die. Similarly, a positive x-axis movement of the MEMS die corresponds to a negative signed increase in the net pressure on the PMUT membrane, corresponding to the pressure profiles 250 and 350, as well as acoustic mode 2 of FIG. 4, in which the depicted acoustic resonance mode has a negative net pressure in the positive x-direction from the neutral pressure line/location over the MEMS die. The “zero” location on the x-axis of plot 502 corresponds to a zero net pressure, for example, as depicted in FIG. 3.

Plot 504 depicts the impact of changes in the thickness (e.g., height) of the ASIC die within the back cavity on the overall net pressure experienced by the PMUT membrane due to the specific acoustic mode depicted in FIG. 5. The abscissa of plot 504 corresponds to the z-axis thickness of the ASIC within the back volume and is in units of micrometers (μm) while the ordinate of plot 504 corresponds to a normalized net pressure on the PMUT membrane ranging from +1 to −1. As is depicted by plot 504, the ASIC height changes the characteristics (e.g., including neutral pressure locations) of the acoustic resonance mode. A “zero” value for the thickness of the ASIC in plot 504 corresponds to the ASIC height at which the net pressure on the PMUT membrane is zero, while changing the height results in a change in the net pressure on the PMUT membrane.

Plot 506 depicts the impact of changes in the x-axis location of the lid of the PMUT sensor package on the overall net pressure experienced by the PMUT membrane due to the specific acoustic mode depicted in FIG. 5. The abscissa of plot 506 corresponds to the x-axis location of the lid (e.g., assuming identical overall dimensions of the lid, moving the lid laterally along the x-axis on the base substrate to a different location relative to the MEMS and ASIC die) in units of micrometers (μm) while the ordinate of plot 506 corresponds to a normalized net pressure on the PMUT membrane ranging from +1 to −1. As is depicted by plot 506, the lid x-axis location changes the characteristics (e.g., including neutral pressure locations) of the acoustic resonance mode. A “zero” value for the lid location in plot 504 corresponds to the lid location at which the net pressure on the PMUT membrane is zero, while changing the x-axis location results in a change in the net pressure on the PMUT membrane.

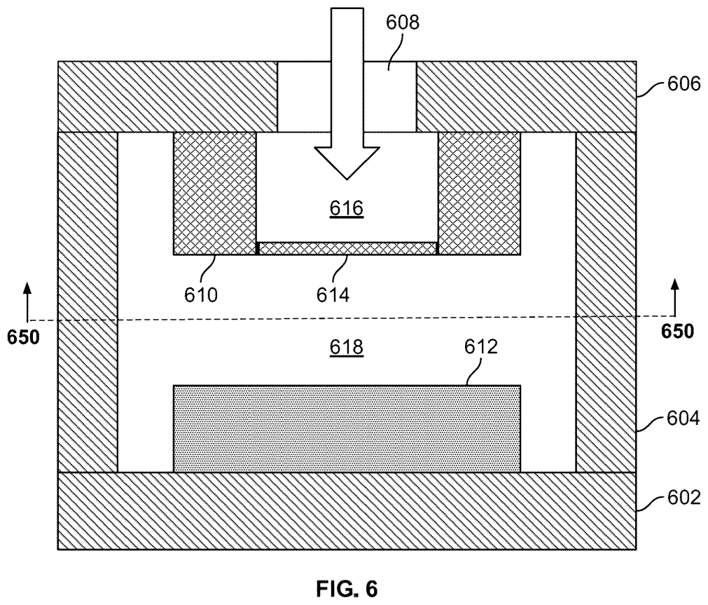

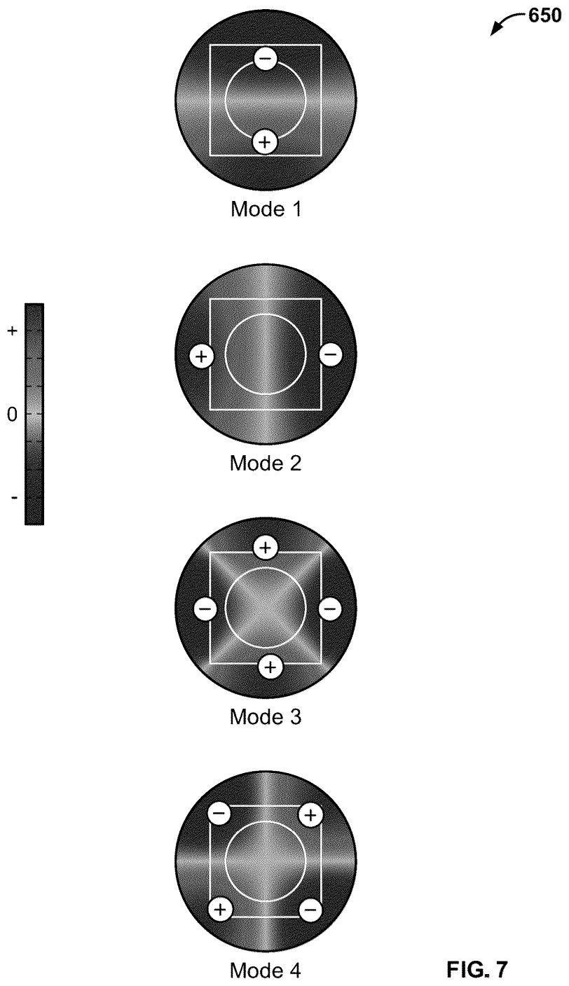

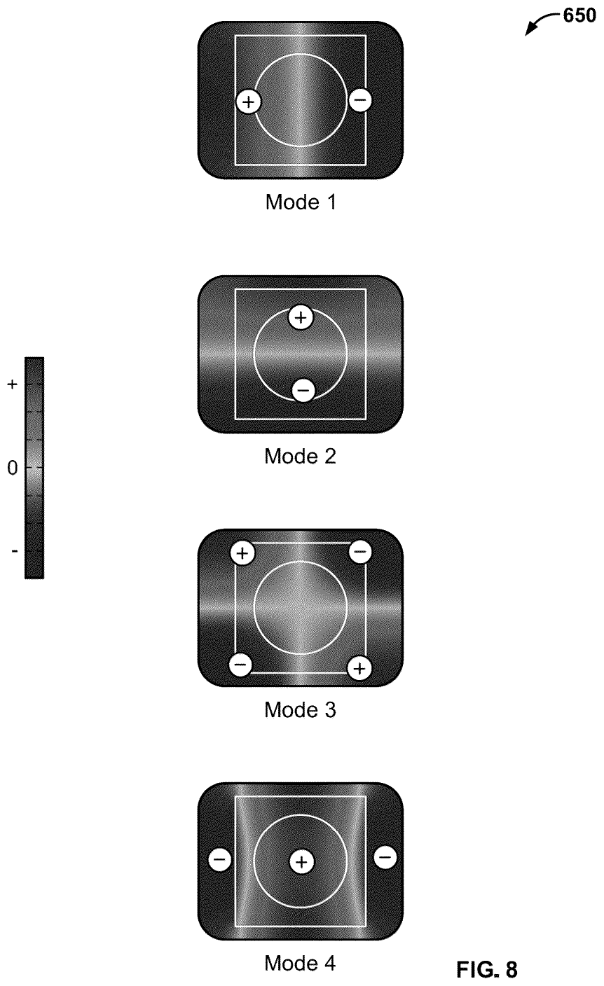

FIG. 6 depicts a horizontal section view of an exemplary top-port PMUT sensor in accordance with an embodiment of the present disclosure. It is understood that a PMUT sensor may have a number of different configurations and components. In this exemplary embodiment, the device includes a MEMS package compromised of a base substrate layer 602, sidewall layer 604, and cap substrate layer 606 through which port 608 provides access to the external environment. The PMUT MEMS die 610 is fixed to the cap substrate layer 606, wherein the volume that is in fluidic communication with port 606, enclosed by the MEMS die 610, and in contact with membrane 614, defines a front cavity 616. Additionally, processing circuitry such as an ASIC die 612 is located within an enclosed volume of the PMUT sensor package, for example, bonded to the base substrate layer 602. In the embodiment of FIG. 6, the enclosed interior volume of the PMUT sensor package is a back cavity 618 that is defined by the geometrical configurations of the internal faces of the base substrate layer 602, sidewall layer 604, cap substrate layer 606, and the internal components (such as the MEMS die 610 and ASIC die 612). Section line 650 is used as a reference for FIG. 7 (e.g., a PMUT sensor with a cylindrical back cavity) and FIG. 8 (e.g., a PMUT sensor with a rectangular back cavity). Further, the shape of the PMUT MEMS die 610 and membrane 614 may have a variety of shapes (e.g., circular, rectangular, oval, irregular, etc.), such as the rectangular MEMS die 610 and circular membrane 614 depicted in FIGS. 7 and 8. In the exemplary embodiment, the components are shown at specific positions with particular dimensions, but they may be modified to accommodate different PMUT configurations and designs. Further, additional components may be added and/or removed, and the relative positions of the components may be altered (e.g., moving the ASIC die to the exterior of the lid or adding a filler material within the back cavity).

FIG. 7 depicts a plurality of acoustic pressure profiles based on a top view from section line 650 for a circular version of the PMUT sensor of FIG. 6 corresponding to different acoustic resonance modes of a back cavity in the PMUT sensor package in accordance with an embodiment of the present disclosure. The respective phases of the pressure profile are represented as dark gray, while neutral pressures are represented as light gray. The respective phases of the time-harmonic pressure of the acoustic resonance modes are indicated by a “+” or “−” symbol. It will be understood that different PMUT designs and configuration will have different numbers and types of acoustic resonance modes within the operating frequency band, and that a depiction similar to FIG. 7 can be provided for such designs. In the exemplary embodiment of FIG. 7, four acoustic resonance modes are depicted for a circular version of a PMUT design such as that depicted in FIG. 6.

In the embodiment of FIG. 7, acoustic resonance mode 1 may occur at a frequency of 45 kHz, acoustic resonance mode 2 may occur at a frequency of 60 kHz, acoustic resonance mode 3 may occur at a frequency of 85 kHz, and acoustic resonance mode 4 may occur at a frequency of 105 kHz. It will be understood that different PMUT sensor designs and configurations will have different numbers of relevant back cavity acoustic resonance modes occurring at different frequencies, and the present disclosure may similarly be applied to other such designs and configurations by simulating back cavity acoustic resonance modes relative to the physical location of the membrane of the PMUT sensor package, utilizing test equipment to modify membrane locations and/or acoustic resonance modes, and/or testing a variety of prototypes with predetermined modifications to the membrane location and/or PMUT sensor configurations. In the embodiment of FIG. 7, the acoustic resonance modes of the back cavity may be analyzed to determine an available operating frequency range for the PMUT sensor as designed.

As depicted for acoustic resonance mode 1 of FIG. 7 (e.g., corresponding to 45 kHz), pressure is balanced over the PMUT membrane with equal and opposite positive and negative phase pressure regions on each side of the horizontal lateral symmetry line of the membrane. For acoustic resonance mode 2 of FIG. 7 (e.g., corresponding to 60 kHz), pressure is balanced over the PMUT membrane with equal and opposite positive and negative phase pressure regions on each side of the vertical lateral symmetry line of the membrane. For acoustic resonance mode 3 of FIG. 7 (e.g., corresponding to 85 kHz), pressure is balanced over the PMUT membrane with equal and opposite positive and negative phase pressure regions in each of four quadrants about the center point of the membrane and at 45° with respect to the membrane horizontal and vertical lateral symmetry lines. For acoustic resonance mode 4 of FIG. 7 (e.g., corresponding to 105 kHz), pressure is balanced over the PMUT membrane with equal and opposite positive and negative phase pressure regions in each of four quadrants about the center point of the membrane and aligned with respect to the membrane horizontal and vertical lateral symmetry lines. Accordingly, all four of the acoustic resonance modes between 45 kHz and 105 kHz have their pressure profiles balanced over the membrane of the PMUT sensor package and thus are decoupled from PMUT operation within these frequency ranges. Based on the above, an operating frequency range for the PMUT sensor of FIG. 7 may be at least from 45 kHz-105 kHz (e.g., with possible additional range based on known frequencies of the next acoustic resonance modes below 45 kHz and above 105 kHz).

FIG. 8 depicts a plurality of acoustic pressure profiles based on a top view from section line 650 for a rectangular version of the PMUT sensor of FIG. 6 corresponding to different acoustic resonance modes of a back cavity in the PMUT sensor is in accordance with an embodiment of the present disclosure. The negative and positive pressures across a location are represented as dark gray, while neutral pressures are represented as light gray. The respective phases of the time-harmonic pressure of the acoustic resonance modes are indicated by a “+” or “−” symbol. It will be understood that different PMUT designs and configuration will have different numbers and types of acoustic resonance modes, and that a depiction similar to FIG. 8 can be provided for such designs. In the exemplary embodiment of FIG. 8, four acoustic resonance modes are depicted for a rectangular version of a PMUT design such as that depicted in FIG. 6.

In the embodiment of FIG. 8, acoustic resonance mode 1 may occur at a frequency of 50 kHz, acoustic resonance mode 2 may occur at a frequency of 65 kHz, acoustic resonance mode 3 may occur at a frequency of 80 kHz, and acoustic resonance mode 4 may occur at a frequency of 105 kHz. It will be understood that different PMUT sensor designs and configurations will have different numbers of relevant back cavity acoustic resonance modes occurring at different frequencies, and the present disclosure may similarly be applied to other such designs and configurations by simulating back cavity acoustic resonance modes relative to the physical location of the membrane of the PMUT sensor package, utilizing test equipment to modify membrane locations and/or acoustic resonance modes, and/or testing a variety of prototypes with predetermined modifications to the membrane location and/or PMUT sensor configurations. In the embodiment of FIG. 8, the acoustic resonance modes of the back cavity may be analyzed to determine an available operating frequency range for the PMUT sensor as designed.

As depicted for acoustic resonance mode 1 of FIG. 8 (e.g., corresponding to 50 kHz), pressure is balanced over the PMUT membrane with equal and opposite positive and negative phase pressure regions on each side of the vertical lateral symmetry line of the membrane. For acoustic resonance mode 2 of FIG. 8 (e.g., corresponding to 65 kHz), pressure is balanced over the PMUT membrane with equal and opposite positive and negative phase pressure regions on each side of the horizontal lateral symmetry line of the membrane. For acoustic resonance mode 3 of FIG. 8 (e.g., corresponding to 80 kHz), pressure is balanced over the PMUT membrane with equal and opposite positive and negative phase pressure regions in each of four quadrants about the center point of the membrane and aligned with respect to the membrane horizontal and vertical lateral symmetry lines. For acoustic resonance mode 4 of FIG. 8 (e.g., corresponding to 105 kHz), a positive phase pressure occurs over almost the entirety of the membrane of the PMUT sensor package, with opposite negative phase pressure largely present adjacent to the membrane. Accordingly, a large positive net pressure is applied to the membrane in acoustic resonance mode 4 such that the acoustic resonance mode 4 of the back cavity will be excited during operation of the PMUT sensor, resulting in a substantial reduction of transmit and receive power and reduced signal-to-noise ratio. Based on the above results, an operating frequency range for the PMUT sensor of FIG. 8 may be at least from 50 kHz-85 kHz (e.g., with possible additional range based on known frequencies of the next acoustic resonance mode below 50 kHz or above 85 kHz and a guard band range such as 5% to 10%).

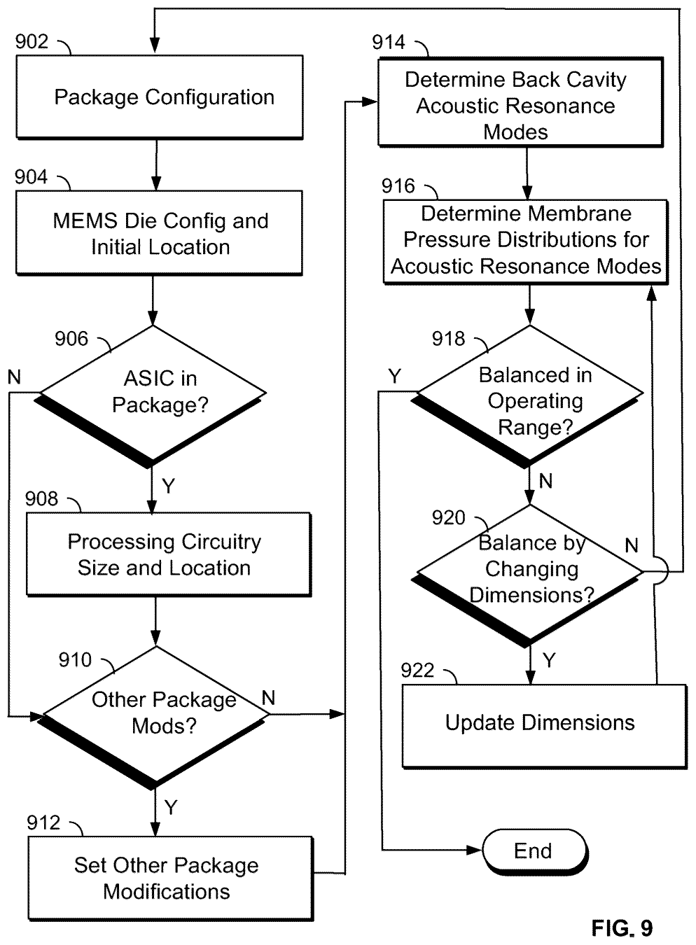

FIG. 9 depicts exemplary steps of designing a PMUT sensor with a balanced membrane and decoupled back cavity acoustic resonance modes in accordance with an embodiment of the present disclosure. Although particular steps are depicted in a certain order for FIG. 9, steps may be removed, modified, and substituted. Further, additional steps (and the order of those steps) may be added in certain embodiments.

Processing starts at step 902, where the configuration of the PMUT sensor is decided. The PMUT sensor includes characteristics such as the design of the device (e.g., top-port design), along with the overall package shape (e.g., oval, rectangular, polygon, irregular, etc.). The materials and thickness for the base substrate and lid (if applicable) can be chosen. These properties will impact the overall footprint of the device, define the constraints for the inclusion of any components (e.g., MEMS die of the PMUT), impact the volume of the back cavity, and affect the acoustic resonance modes present within the back cavity. Once the package configuration is set, processing may continue to step 904.

At step 904, the configuration of the MEMS die may be decided, along with its initial spatial location within the device. General parameters such as shape, size, material, membrane thickness, spatial location within the PMUT sensor package, inclusion of any die encapsulation materials (e.g., epoxies, films), among others may be determined. The volume of the back cavity, along with its acoustic resonance modes will be impacted by the configuration of the MEMS die. Once the MEMS die configuration and spatial location is set, processing may continue to step 906.

At step 906, it may be determined if an ASIC and/or other processing circuitry is included within the back cavity of the PMUT sensor package. When co-located with the MEMS die within the back cavity, the size, shape, location, and materials may impact the back cavity acoustic resonance modes. If the ASIC die is to be included within the back cavity, processing may continue to step 908. If the ASIC die is not to be included in the package, processing may continue to step 910.

At step 908, the configuration of the processing circuitry (e.g., ASIC) within the back cavity, along with its initial spatial location within the back cavity. General parameters such as shape, size, material, location within the PMUT sensor package (e.g., exterior of the package), inclusion of any die encapsulation materials (e.g., epoxies, films), among others may be determined. The volume of the back cavity, along with its acoustic resonance modes may be impacted by the configuration of the processing circuitry. Once the processing circuitry configuration and location is set, processing may continue to step 910.

At step 910, the inclusion of any other modifications within the back cavity may be assessed. In some cases the addition of other elements (e.g., overmold materials) may be included. If other package modifications are to be included within the back cavity, processing may continue to step 912. If other package modifications are not to be included within the back cavity, processing may continue to step 914.

At step 912, the configuration of the package modifications may be decided. General parameters such as size, material, thickness, location within the PMUT sensor package, among others may be determined. The volume of the back cavity, along with its acoustic resonance modes may be impacted by the configuration of the package modifications. Once the package modification configuration is set, processing may continue to step 914.

At step 914, tests and/or simulations may be performed to determine the acoustic resonance modes of the back cavity. The back cavity is defined by a number of characteristics such as the geometrical configuration, thickness, and spatial location of the base substrate, lid, MEMS die, and processing circuitry (e.g., ASIC die). The presence of other sensors, components, and encapsulation materials will also directly impact the enclosed volume, and this volume and the associated component dimensions will directly impact the acoustic resonance mode frequencies and pressure profiles. All these characteristics and configurations will alter the number and specific characteristics (e.g., pressure profile, amplitude, etc.) of the acoustic resonance modes present within the back cavity. The acoustic vibrations produced by the PMUT membrane may couple with such acoustic resonance modes leading to signal interference and attenuation, which would reduce the overall efficiency of the PMUT sensor (i.e., energy sent by the membrane to produce acoustic waves within the front cavity and exit through the port would be used to excite the volume within the back cavity, thus reducing the overall amplitude and number of acoustic waves exiting through the port, with similar signal loss on reception of reflected acoustic signals). Once the acoustic resonance modes of the back cavity are determined, processing may continue to step 916.

At step 916, the acoustic pressure distributions across the PMUT membrane for the acoustic resonance modes (determined in step 914) may be determined. The number and spatial location of the pressure nodes (where pressure is balanced) within the acoustic pressure profile may be noted. Once the acoustic pressure profiles across the membrane are determined, processing may continue to step 918.

At step 918, it may be determined if the acoustic pressure profiles across the PMUT membrane are balanced within the sensor's operating range. The alignment of the spatial lateral symmetry lines of the PMUT membrane may be compared to the pressure profiles applied to the membrane by the acoustic resonance modes during this step. If the net pressure on the PMUT membrane is balanced (e.g., within a threshold of 1%, 3%, 5%, or other similar thresholds) for the acoustic resonance modes for the relevant operating frequency range of the PMUT sensor, the acoustic resonance modes are decoupled from the PMUT sensor operation and processing is complete. If a balanced net pressure is not obtained at the PMUT membrane over the operating frequency range, processing continues to step 920.

At step 920, it may be decided if the unbalanced acoustic pressure profiles across the PMUT membrane may become balanced by altering dimensions or locations of PMUT sensor components. Locations and/or dimensions of the ASIC, MEMS die, port hole, lid, base substrate within the package may affect the acoustic pressure profiles across the entire device. Thus, shifting the locations and/or modifying dimensions of one or more of these components of the PMUT sensor may allow for the alignment of its spatial lateral symmetry lines with the pressure node lines in order to yield a balance acoustic pressure profile across the membrane. If a balanced acoustic pressure profile across the membrane may be achieved via changing the PMUT sensor locations and/or dimensions, processing may continue to step 922. If changing the PMUT sensor locations and/or dimensions will not yield a balanced acoustic pressure profiles across the membrane, processing continues to step 902 to consider more significant modifications to the configuration of the PMUT sensor as a whole.

At step 922, the new locations and/or dimensions of the components of the PMUT sensor may be updated. Processing then returns to step 916 to determine the membrane pressure distributions, and the processing may continue to loop through steps 916-922 to optimize the PMUT sensor design until a desired measure of PMUT membrane balance is achieved at step 918.

The foregoing description includes exemplary embodiments in accordance with the present disclosure. These examples are provided for purposes of illustration only, and not for purposes of limitation. It will be understood that the present disclosure may be implemented in forms different from those explicitly described and depicted herein and that various modifications, optimizations, and variations may be implemented by a person of ordinary skill in the present art, consistent with the following claims.

What is claimed is:

1. An ultrasonic sensor, comprising:
a sensor package comprising:
a back cavity having an acoustic resonance mode at a first frequency; and
a port exposed to an external environment; and
a microelectromechanical system (“MEMS”) die exposed to the back cavity and the port, the MEMS die comprising a membrane of the ultrasonic sensor having an operating frequency range that includes the first frequency, wherein based on a location of the MEMS die within the back cavity an applied acoustic pressure on the membrane corresponding to the acoustic resonance mode is balanced over the membrane.

2. The ultrasonic sensor of claim 1, wherein, when the membrane receives an electrical transmission signal to convert into a transmitted acoustic signal within the operating frequency range, the balance of the applied acoustic pressure of the acoustic resonance mode prevents energy of the electrical transmission signal from being used to excite the acoustic resonance mode of the back cavity.

3. The ultrasonic sensor of claim 1, wherein, when the membrane receives an acoustic signal to convert into an electrical signal within the operating frequency range, the balance of the applied acoustic pressure of the acoustic resonance mode prevents energy of the received acoustic signal from being used to excite the acoustic resonance mode of the back cavity.

4. The ultrasonic sensor of claim 1, wherein the acoustic resonance mode comprises a first acoustic resonance mode having a first applied acoustic pressure, further comprising a second acoustic resonance mode at a second frequency within the operating frequency range of the membrane, wherein based on the location of the MEMS die within the sensor package a second applied acoustic pressure on the membrane corresponding to the second acoustic resonance mode is balanced over the membrane.

5. The ultrasonic sensor of claim 4, further comprising a third acoustic resonance mode at a third frequency within the operating frequency range of the membrane, wherein based on the location of the MEMS die within the sensor package a third applied acoustic pressure on the membrane corresponding to the third acoustic resonance mode is balanced over the membrane.

6. The ultrasonic sensor of claim 5, further comprising a fourth acoustic resonance mode at a fourth frequency within the operating frequency range of the membrane, wherein based on the location of the MEMS die within the sensor package a fourth applied acoustic pressure on the membrane corresponding to the fourth acoustic resonance mode is balanced over the membrane.

7. The ultrasonic sensor of claim 5, further comprising a fourth acoustic resonance mode at a fourth frequency outside of the operating frequency range of the membrane, wherein based on the location of the MEMS die within the sensor package a fourth applied acoustic pressure on the membrane corresponding to the fourth acoustic resonance mode is not balanced over the membrane.

8. The ultrasonic sensor of claim 1, further comprising a second acoustic resonance mode at a second frequency outside of the operating frequency range of the membrane, wherein based on the location of the MEMS die within the sensor package a second applied acoustic pressure on the membrane corresponding to the second acoustic resonance mode is not balanced over the membrane.

9. The ultrasonic sensor of claim 1, further comprising processing circuitry located within the sensor package, wherein the processing circuitry is configured to provide an electrical transmission signal within the operating frequency range to the membrane to cause the membrane to transmit an acoustic signal within the operating frequency range via the port.

10. The ultrasonic sensor of claim 9, wherein the processing circuitry is further configured to receive an electrical reflection signal based on a reflection of the transmitted acoustic signal received by the membrane via the port.

11. The ultrasonic sensor of claim 9, wherein the location of the MEMS die within the sensor package is based at least in part on a location and size of the processing circuitry within the sensor package.

12. The ultrasonic sensor of claim 1, wherein the package comprises a base substrate and a lid, wherein the port is located in the base substrate, wherein a first portion of the MEMS die surrounds the port such that the membrane faces the port, and wherein the back cavity encloses a volume of air defined by the lid, an internal surface of the base substrate, and a second portion of the MEMS die opposite the first portion.

13. The ultrasonic sensor of claim 12, wherein the volume of air is further defined by a processing circuitry located within the back cavity.

14. The ultrasonic sensor of claim 1, wherein the sensor package comprises at least three stacked layers, wherein the port is located in a first layer of the stacked layers, wherein a first portion of the MEMS die surrounds the port such that the membrane faces the port, wherein a second layer is located parallel to the first layer, and wherein a third layer couples the first layer to the second layer to define the back cavity.

15. The ultrasonic sensor of claim 1, wherein the back cavity has one of a rectangular shape, a circular shape, an oval shape, a polygon shape, or an irregular shape.

16. The ultrasonic sensor of claim 1, wherein the membrane has one of a rectangular shape, a circular shape, an oval shape, a polygon shape, or an irregular shape.

17. The ultrasonic sensor of claim 1, wherein the applied acoustic pressure comprises a first pressure region applying a first net pressure to a first portion of the membrane on a first lateral side of the membrane and a second pressure region applying a second net pressure that is equal and opposite to the first pressure to a second portion of the membrane on a second lateral side that is opposite the first side.

18. The ultrasonic sensor of claim 17, wherein a lateral symmetry line of the membrane separates the first side from the second side, and wherein the second portion of the membrane is located on a second side of the symmetry line opposite the first portion of the membrane on a first side of the symmetry line.

19. The ultrasonic sensor of claim 17, wherein the lateral center location of the membrane corresponds to a symmetry line of the back cavity.

20. The ultrasonic sensor of claim 1, wherein the location of the MEMS die within the sensor package is based at least in part on a location and size of a filler material within sensor package.

21. The ultrasonic sensor of claim 1, wherein a volume of the back cavity is filled with air approximately at an atmospheric pressure.

22. A piezoelectric micromachined ultrasound transducer (PMUT) sensor, comprising:
a sensor package comprising:
a back cavity having an acoustic resonance mode at a first frequency; and
a port exposed to an external environment; and
a PMUT membrane located within the sensor package and having an operating frequency range that includes the first frequency, wherein based on a location of the membrane within the sensor package an applied acoustic pressure on the membrane corresponding to the acoustic resonance mode is balanced over the membrane.

23. A piezoelectric micromachined ultrasound transducer (PMUT) sensor, comprising:
a lid;
a base substrate, wherein the lid and substrate define a back volume;
processing circuitry located within the back volume; and
a membrane of the PMUT sensor located within the back volume, wherein based on a location of the membrane within the back volume an applied acoustic pressure on the membrane corresponding to an acoustic resonance mode of the back volume is balanced over the membrane.
